(19) United States
(12) Patent Application Publication
(10) Pub. No.: US 2006/0266964 A1
(43) Pub. Date: Nov. 30, 2006

(54) QUICK COUPLER FOR LIQUID FLOW LINES

(76) Inventor: LEO C. FARLEY, Wetaskiwin (CA)

Correspondence Address: DONALD V. TOMKINS;C/O TOMKINS LAW OFFICE, 740, 10150 - 100 STREET, EDMONTON, AB, T5J 0P6, CA

(21) Appl. No.: 11/382,429

(22) Filed: May 9, 2006

Related U.S. Application Data
(60) Provisional application No. 60/679,238, filed on May 10, 2005.

(51) Int. Cl. F16K 31/44

(52) U.S. Cl. 251/82

(57) ABSTRACT

A quick coupler for fluid lines includes a socket body housing a first popper valve; a socket collar mounted around the socket body, and having a plurality of locking lobes; a plug body housing a second poppet valve; and a plug collar mounted around the plug body, with locking slots for receiving the locking lobes, each locking slot having an entry leg and a lateral leg. The socket body may be attached to a first hose and the plug body may be attached to a second hose. When the plug body/collar assembly is urged, under longitudinal force, into engagement with the socket body/collar assembly, the plug body enters a cavity in the socket body, while the poppet valves are forced against each other and thus opened, bringing the hoses into fluid communication. Concurrently, the locking lobes enter corresponding entry legs of the locking slots and come into alignment with the corresponding lateral legs. The socket collar and plug collar may then be rotated relative to each other to move the locking lugs into their respective lateral legs, preventing separation of the quick coupler.

### CROSS-REFERENCE TO RELATED APPLICATIONS

This application claims the benefit, pursuant to 35 U.S.C. 119(e), of U.S. Provisional Application No. 60/679,238, filed on May 10, 2005, and said provisional application is incorporated herein by reference in its entirety.

### FIELD OF THE INVENTION

The present invention relates in general to devices for connecting liquid flow lines. More particularly, the invention relates to quick-connect couplers for hydraulic fluid lines.

### BACKGROUND OF THE INVENTION

In many industrial applications, it is commonly necessary or desirable to connect liquid-carrying conduits such as flexible hoses carrying pressurized hydraulic fluid. Hydraulic hoses are used in many types of equipment, including stationary plant equipment as well as mobile equipment such as front-end loaders and bulldozers.

There are many known means for connecting hydraulic hoses. In numerous applications, it is particularly desirable to be able to connect or disconnect hydraulic hose connectors both easily and quickly, without the need for specialized tools or equipment, and various types of “quick couplers” have been developed for this purpose.

One well-known and widely-used quick coupler is the sleeve-type coupler available from a number of manufacturers, as exemplified by the Series 1-HK coupler manufactured by the Tuthill Corporation (head office in Burr Ridge, Ill.), and the H-Series coupler manufactured by Perfecting Coupling Company (Charlotte, N.C.). Using this type of coupler, one hose is connected (typically by means of a threaded fitting) to a socket body and the other hose is connected to a plug body. The plug body has a plug section with a cylindrical outer surface, and the socket body has a cylindrical socket cavity with a cylindrical inner surface having a diameter slightly larger than that of the inner surface of the socket body, such that the pug section is insertable into the socket cavity.

The socket body and the plug body each incorporate a poppet valve, with a spring that biases the valve toward a closed position in which liquid flow is prevented. A cylindrical sleeve is retainingly disposed around the socket body, with a sleeve spring that biases the sleeve toward the outer end of the socket body (this may be referred to as the locked position). The socket body also has a plurality of locking balls retainingly housed within corresponding openings in the cylindrical wall of the socket body, arrayed in a circumferential ring around the socket body near its inner end (i.e., the end farthest from the hose or conduit to which it is connected.) The sleeve is configured such that when it is in the locked position, it presses radially inward against the locking balls such that a portion of each locking ball projects radially inward beyond the cylindrical inner surface of the socket body. The plug body has an annular groove into which the locking balls may partially project when the sleeve is in the locked position, with the annular groove aligned with the ring of locking balls in the socket body.

The coupler is used by first retracting the sleeve (thus compressing the sleeve spring) so that the locking balls are free to move radially outward within their corresponding openings without projecting into the cavity of the socket body. With the sleeve being held in the retracted potion, the plug body is then inserted into the socket body such that the poppet valves of the plug body and the socket body are forced against each other, compressing the valve springs and opening the valves such that the hoses connected to the plug body and socket body come into fluid communication. The plug body and socket body are configured such that when the plug body has been inserted into the socket body far enough to open the poppet valves, the annular groove of the plug body will be substantially aligned with the locking balls of the socket body. At this stage the sleeve may be released (or it may have been previously released after initial insertion of the plug body), and the compressed sleeve spring then urges the sleeve back to the locked position, simultaneously causing the locking balls to project partially into the annular groove of the socket body, thereby preventing longitudinal displacement (i.e., disconnection) of the plug body relative to the socket body. Fluid is now free to flow between the hoses. Leakage within the connected coupler assembly is prevented by means of an O-ring disposed in an O-ring groove inside the socket cavity such that the plug body passes through and seals against the O-ring when the plug body is inserted into the socket body.

To disengage the coupler, the sleeve is retracted such that the locking balls are no longer forced to extend into the annular groove of the plug body, whereupon the plug body can freely exit the socket body. The withdrawal of the plug body relieves the axially force holding the poppets open, such that the compressed valve springs urge the poppet valves back to their closed position, which has the effect of disengaging the plug body from the socket body. The valve springs are typically of sufficient strength that they will close the poppets quite quickly upon disconnection of the coupler, so as to eliminate or minimize any leakage from the hoses during the disconnection process.

Typically, the coupler cannot be disconnected while the fluid in the hoses is flowing under pressure; the pressure in the hoses will make it difficult or impossible to move the sleeve from the locked position. As a general rule, therefore, the fluid pressure needs to be relieved in order to disconnect the coupler.

Sleeve-type quick couplers, as described above, allow hydraulic hoses to be connected and disconnected quickly and easily in most normal service conditions. However, if dirt or dust or other contaminants are allowed to enter the space between the sleeve and the socket body, the sleeve can become difficult or impossible to move. In order to disconnect the connected hoses in such situations, it may be necessary to use a hammer or other tool to force the sleeve black on the socket body. This is a particular problem in situations where hydraulic connections must be made and disconnected in outdoor field conditions, such as during well-drilling operations in the oil and gas industry, which commonly involve the need to connect and disconnect hydraulic hoses on a regular and repeated basis.

Another drawback of the sleeve-type quick coupler is that its engagement entails application of two separate longitudinal forces. A first longitudinal force must be applied to the sleeve to retract it from the locked position and allow insertion of the plug section of the plug body, and a second longitudinal force must be applied to force the poppet valves against each other. It would be desirable to have a quick coupler which entails the application of only one longitudinal force in order to engage the coupler assembly.

For the foregoing reasons, there is a need for an improved quick coupler that does not have a sliding sleeve and thus is less prone to jamming or seizing due to entry of dust or other contaminants. There is a further need for an improved quick coupler that can be engaged by application of only a single longitudinal force. The present invention is directed to these needs.

### BRIEF SUMMARY OF THE INVENTION

In general terms, the present invention is an apparatus for connecting a pair of fluid conduits, comprising the following primary components:
(a) a socket body with a spring-loaded poppet valve, similar to a socket body/poppet valve assembly of the prior art sleeve-type couplers previously described, but with no sleeve and no locking balls (one way of fabricating the socket body of the invention would involve simply modifying a prior art socket body by cutting off the portion that houses the locking balls);
)b) a socket collar mounted retainingly and substantially coaxially (and preferably rotatably) around the socket body, with a plurality of circumferentially-arrayed locking lobes;
(c) a plug body with a spring-loaded poppet valve, similar to a plug body/poppet valve assembly of the prior art sleeve-type couplers previously described; and
(d) a plug collar mounted retainingly and substantially coaxially (and preferably rotatably) around the plug body, with locking slots for engagement with the locking lobes of the socket collar;
   wherein the poppet valves of the socket body and the plug body will be opened by the action of engaging the socket collar and plug collar with the locking lobes of the socket collar disposed within the locking slots of the plug collar.

In one embodiment, the plug collar has a plurality of circumferentially spaced, generally L-shaped locking slots, for receiving and retaining corresponding locking lobes on the socket collar. Each locking slot has an entry leg oriented longitudinally (i.e., parallel to the axis of the plug collar), and a contiguous, circumferentially-oriented lateral leg. As well, each locking slot also comprises a detent notch contiguous with the lateral leg, said detent notch being configured for engagement with a corresponding locking lobe so as to prevent relative rotation between the plug collar and socket collar. The detent notch is disposed toward the inner end of the plug collar (i.e., the end farthest from the hose or conduit to which it is connected), so that the locking lobes will be retained within their corresponding detent notches by the longitudinal force exerted by the valve springs.

The plug collar and socket collar are configured and adapted such that they may be releasably engaged by aligning the locking lobes of the socket collar with the corresponding entry legs of the locking slots of the plug collar, and then urging the plug collar and socket collar axially toward each other, such that the locking lobes move into the entry legs of their corresponding locking slots. Because the plug collar and socket collar are retainingly mounted around the plug body and socket body respectively, this action has the effect of forcing the poppet valves of the plug body and the socket body against each other, compressing the valve springs and opening the poppet valves such that the hoses connected to the plug body and socket body come into fluid communication. The socket collar may then be twisted circumferentially in a first direction (typically but not necessarily clockwise) relative to the plug collar, such that the locking lobes move into the lateral legs of their corresponding locking slots. The axial force exerted by the valve springs will then move the locking lobes into the detent notches of their corresponding locking slots in the plug collar, thus preventing both longitudinal displacement and relative rotation between the plug collar and the socket collar.

Disengagement of the quick coupler is accomplished (with fluid pressure in the connected conduits having been relieved) by first applying an axial force to press the socket collar into the plug collar such that the locking lobes move clear to the detent notches of their corresponding locking slots. The socket collar may then be twisted circumferentially in the direction opposite to the previously-mentioned first direction, such that the locking lobes mover out of the lateral legs of their corresponding locking slots, and into general alignment with the entry legs thereof. This action relieves the longitudinal force holding the poppet valves open, such that the compressed valve springs urge the poppet valves back to their closed positions, which has the effect of disengaging the plug body and plug collar from the socket body and socket collar.

### BRIEF DESCRIPTION OF THE DRAWINGS

Embodiments of the present invention will now be described with reference to the accompanying figures, in which numerical referenced denote like parts, and in which:

FIG. 1A is a partial-cutaway side view of the socket body of a prior art sleeve-type quick coupler.

FIG. 1B is a partial-cutaway side view of the plug body of a prior art sleeve-type coupler.

FIG. 2 is a partial-cutaway side view of a socket body in accordance with one embodiment of the present invention.

FIG. 3 is an isometric view of a socket collar in accordance with one embodiment of the present invention.

FIG. 4 is a side view of the socket collar shown in FIG. 3.

FIG. 5 is a cross-sectional view of the socket collar of FIG. 3.

FIG. 6 is a perspective view of a split bushing for mounting the socket collar to a socket body in accordance with one embodiment of the invention.

FIG. 7 is a cross-sectional view of the split busing of FIG. 6.

FIG. 8 is an isometric view of a plug collar in accordance with one embodiment of the present invention.

FIG. 9 is a side view of the plug collar shown in FIG. 8.

FIG. 10 is a cross-sectional view of the plug collar of FIG. 8.

FIG. 11 is a cross-sectional side view of the socket collar of FIG. 3 mounted on the socket body of FIG. 2.

FIG. 12 is a cross-sectional side view of the plug collar of FIG. 8 mounted on a plug body as in FIG. 1B.

FIG. 13 is an isometric view of an exemplary spring retainer suitable for use in association with the invention.

FIG. 14 is a cross-sectional side view of the components of a quick coupler in accordance with an alternative embodiment of the invention.

FIG. 15 is an isometric view of the socket body of the alternative embodiment of FIG. 14.

FIG. 16 is an isometric cross-section of the socket body of FIG. 15.

FIG. 17 is an isometric view of the socket collar of the embodiment of FIG. 14.

FIG. 18 is an isometric cross-section of the socket collar of FIG. 17.

FIG. 19 is an isometric view of the plug body of the embodiment in FIG. 14.

FIG. 20 is an isometric cross-section of the plug body of FIG. 19.

FIG. 21 is an isometric view of the plug collar of the embodiment in FIG. 14.

FIG. 22 is an isometric cross-section of the plug collar of FIG. 21.

### DETAILED DESCRIPTION OF THE PREFERRED EMBODIMENT

An understanding of the present invention may be facilitated by first reviewing prior art sleeve-type quick couplers of the type previously referred to in this specification.

FIG. 1A illustrates a socket body 10 of a prior art sleeve-type quick coupler. Socket body 10 has a generally cylindrical passage 12 extending between a conduit end 14 (for connecting a first fluid conduit, such as by means of a threaded connection as shown) and a socket section 16. A spring retainer 18 is disposed within passage 12, with outward displacement prevented by a snap ring 19 disposed within an annular snap ring groove 19A (or other suitable means engaging socket body 10). Spring retainer 18 has a valve stem opening 18A plus fluid openings 18B. An exemplary spring retainer 18 is shown in FIG. 13; however, those skilled in the art will appreciate that spring retainers 18 of other configurations may be used without departing from the present invention.

Formed into or otherwise disposed within the circumferential surface of passage 12 is an annular valve abutment 20. A poppet valve 30—having a generally conical or mushroom-shaped valve body 32, a valve O-ring 34, and a valve stem 36—is coaxially disposed within passage 12, with valve stem 36 extending through valve stem opening 18A of spring retainer 18 toward connector end 14, and with valve body 32 disposed adjacent valve abutment 20, which is configured for sealing engagement with valve O-ring 34. A helical valve spring 38 is disposed around valve stem 36, extending between spring retainer 18 and valve body 32. Valve spring 38 is installed in a pre-compressed state such that it will bias valve 30 toward the closed position, as shown in FIG. 1A. As shown in FIG. 1A, valve body 32 will typically incorporate a generally flat contact surface 32A, against which an axial force may be applied to urge valve body 32 toward connector end 14 so as to open valve 30 and allow fluid flow through fluid openings 18B.

Socket section 16 has a cylindrical outer surface 16A, and defines a generally cylindrical cavity 22 (with cavity opening 22A) extending toward valve abutment 20, with generally cylindrical cavity wall 24. A plurality of spherical locking balls 26 are retainingly housed within ball openings 26A arrayed in a circular pattern around the circumference of cavity wall 24 adjacent to cavity opening 22A. As may be seen in FIG. 1A, the diameter of each ball opening 26A where they open into cavity 22 is slightly smaller than the diameter of its corresponding locking ball 26, such that a substantial portion of each locking ball 26 can protrude into cavity 22 but without passing fully into it.

A generally cylindrical sleeve 40 is disposed around socket section 16, and is retained thereon between a sleeve abutment 42 attached to or incorporated into outer surface 16A and a sleeve spring retainer 44 mounted to socket section 16. At its end nearest cavity opening 22A, sleeve 40 is formed or provided with a spring abutment 46. Sleeve 40 also incorporates locking ball actuation means, for using locking balls 26 radially inward so that they protrude into cavity 22. In the sleeve 40 shown in FIG. 1A, the locking ball actuation means is incorporated into sleeve abutment 42, which is of annular configuration. A sleeve spring 48 is disposed between sleeve abutment 42 and spring abutment 46, with sleeve spring 48 being pre-compressed so as to bias sleeve 40 toward a locked position (as shown in FIG. 1A), in which locking balls 26 protrude into cavity 22, and are maintained in that position by the locking ball actuation means.

Formed in to the inner surface of cavity wall 24, at a location between valve abutment 20 and locking balls 26, is an annular O-ring groove 24A, into which a socket O-ring 28 is disposed (optionally with a back-up ring 28A as illustrated), for purposes as will be explained herein.

Socket body 10 further defines a mid-section 15 between conduit end 14 and socket section 16. Mid-section 15 has a generally cylindrical outer surface 15A the diameter of which is less than that of socket section 16 and less than the smallest cross-sectional dimension of conduit end 14. Mid-section 15 can thus be considered as defining an annular space 17 surrounding outer surface 15A and extending between conduit end 14 and socket section 16.

FIG. 1B illustrates a plug body 50 of a prior art sleeve-type quick coupler, specifically adapted for mating engagement with socket body 10 of FIG. 1A. Plug body 50 has a generally cylindrical passage 52 extending between a conduit end 54 (for connecting to a second fluid conduit, such as by means of a threaded connection as shown) and a plug section 56. The configuration and features of cylindrical passage 52 are generally similar to the portion of cylindrical passage 12 of socket body 10 between conduit end 14 and valve abutment 20, in that cylindrical passage 52 includes or incorporates a similar spring retainer 18 and valve abutment 20, with a similar poppet valve 30 and valve spring 38 disposed therebetween. Plug section 56 has a cylindrical outer surface 56A and defines a mid-section 55 between conduit end 54 and plug section 56. The diameter of outer surface 56A is smaller than that of cylindrical cavity 22 of socket section 16 generally, and in particular is just slightly smaller than the diameter of cylindrical cavity 22 in the vicinity of O-ring groove 24A and O-ring 28, such that outer surface 56A will be sealingly engaged by O-ring 28 when plug section 56 is fully inserted into cavity 22 of socket section 16. In the configuration shown in FIG. 1A, the diameter of outer surface 56A is also such that plug section 56 cannot be inserted past locking balls 26 when locking balls 26 are protruding into cavity 22.

Mid-section 55 of plug body 50 is fashioned so as to define an annular locking ball groove 57 into which locking balls 26 may protrude when plug section 56 is fully inserted into cavity 22 of socket section 16. The distance between contact surface 32A of valve 30 in socket section 16 and locking balls 26, and the distance between contact surface 32A of valve 30 in plug section 16 and locking ball groove 57, are selected such that both valves 30 will necessarily be in the open position when locking balls 26 are in alignment with locking ball groove 57, such that conduit ends 14 and 54, and the conduits to which they are connected, will be in fluid communication.

The engagement and disengagement of prior art socket body 10 and plug body 50 may be readily understood from FIGS. 1A and 1B. A longitudinal force (acting leftward, as viewed in FIG. 1A) is applied to sleeve 40 so as to move it to a retracted position, in which locking balls 26 will be free to move radially outward within their corresponding ball openings 26A. Plug section 56 can then be inserted fully into cavity 22 of socket section 16 until contact surfaces 32A of valves 30 meet, whereupon a longitudinal force pressing socket body 10 and plug body 50 together will also urge valves 30 against each other until they open. At this stage the retracting force applied to sleeve 40 may be relaxed (if not previously relaxed after initial insertion of plug section 56 past locking balls 26), such that sleeve spring 48 urges sleeve 40 toward the locked position, in which sleeve 40 exerts a radially inward force on locking balls 26. When plug section 56 has been inserted to the point that locking balls 26 are coincident with locking ball groove 57, the radial force exerted by sleeve 40 will force locking balls 26 radially inward so that they project into locking ball groove 57, thus preventing longitudinal separation between socket body 10 and plug body 50. Disengagement of socket body 10 and plug body 50 from each other is accomplished by retracting sleeve 40, such that locking balls 26 will once again be free to move radially outward within their corresponding ball openings 26A, such that plug section 56 may be freely withdrawn (or ejected, by the force of valve springs 38) from socket section 16.

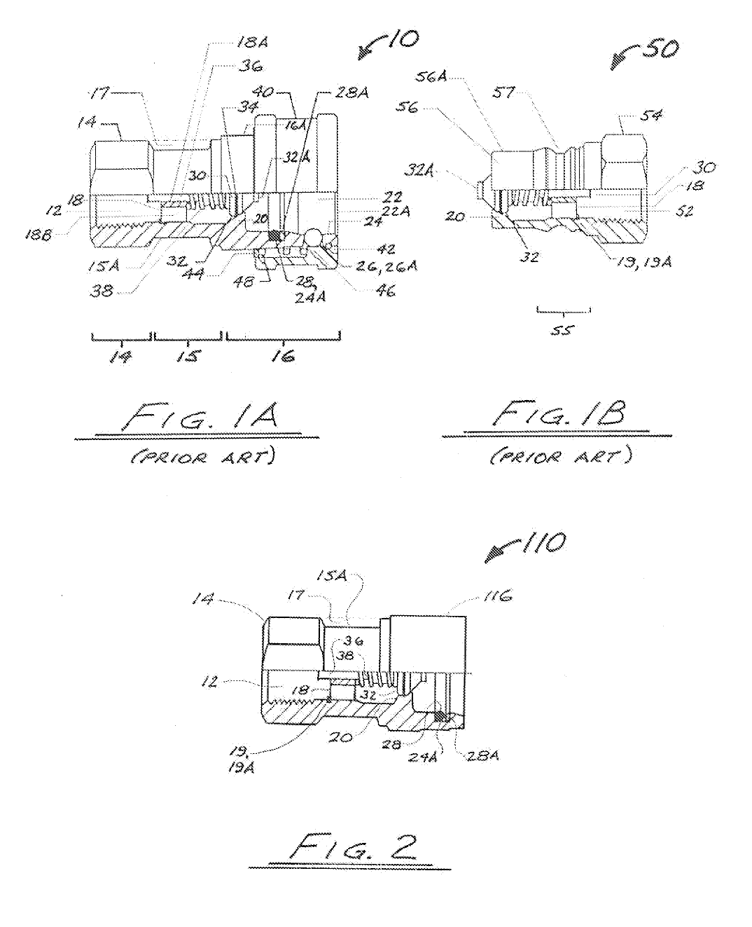

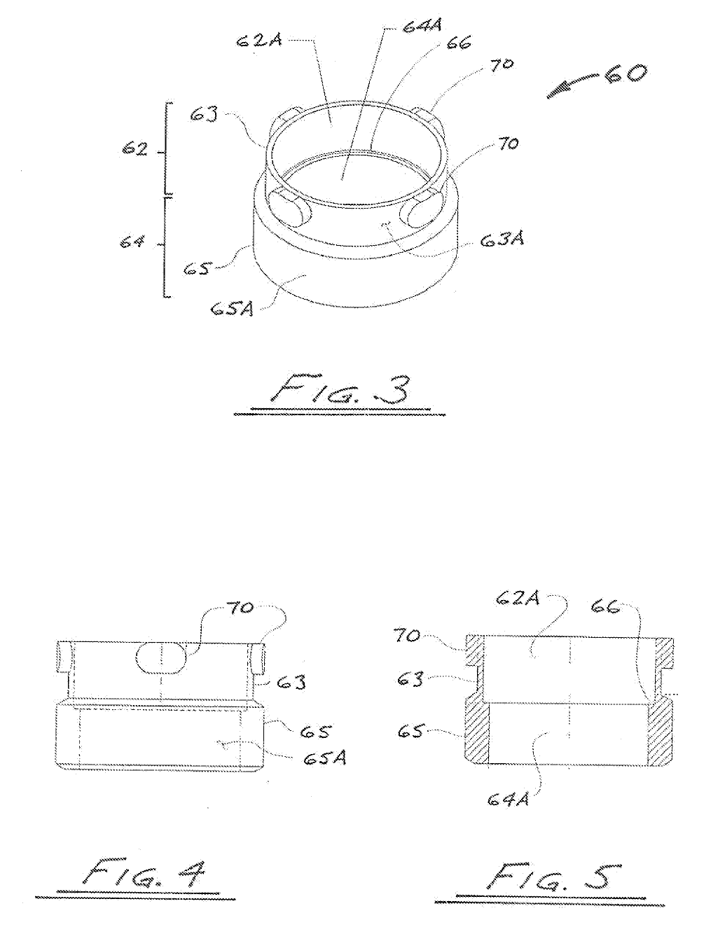

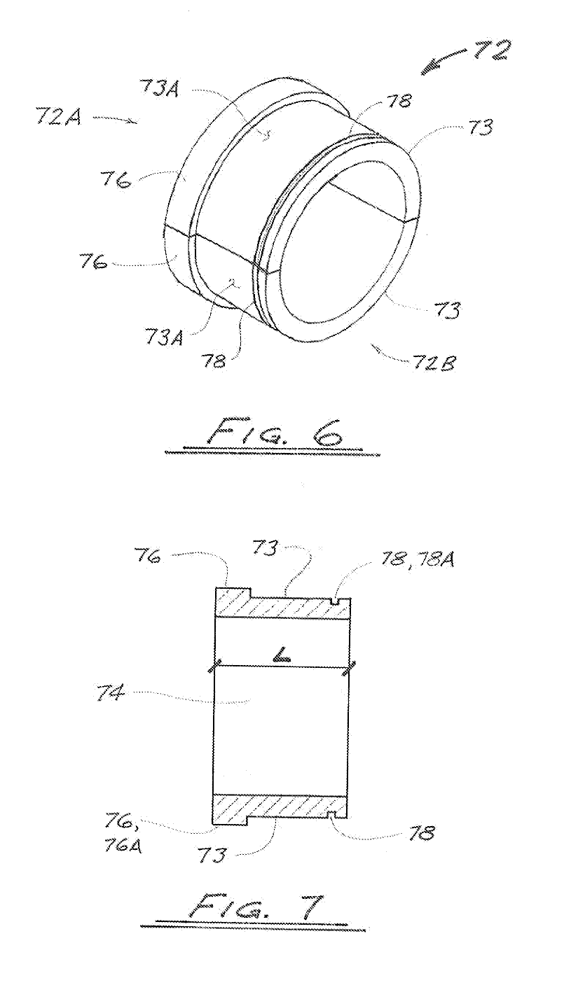

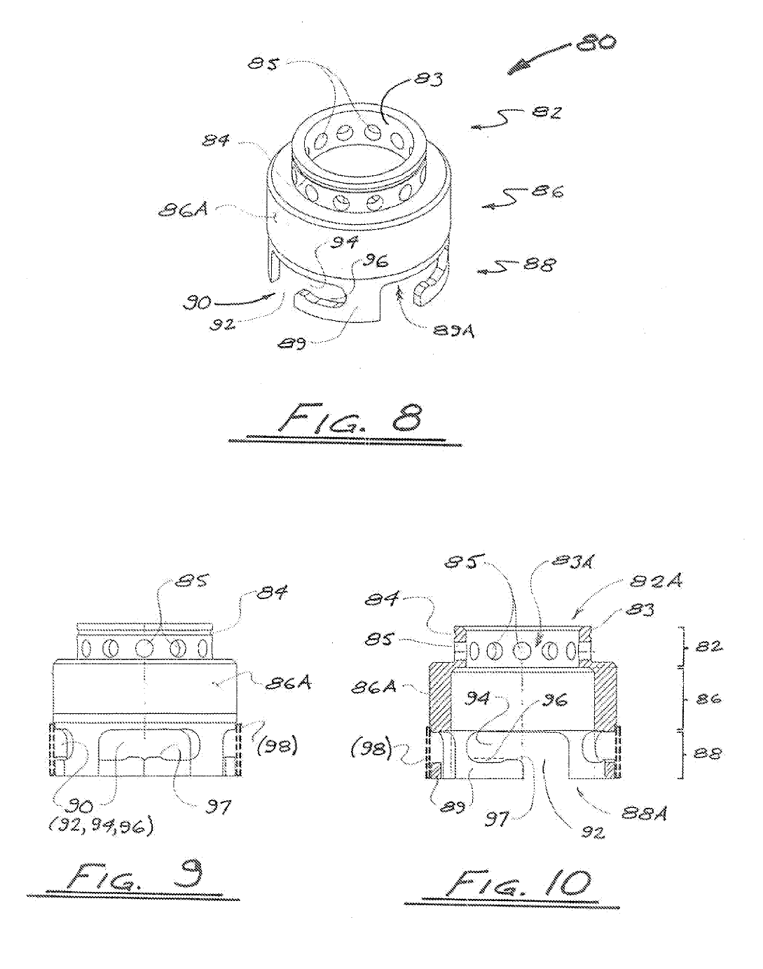

In the preferred embodiment, the quick coupler assembly of the present invention comprises, as one of its components, a plug body 50 generally as described above. It also comprises a socket body 110 as illustrated in FIG. 2. It will be seen that socket body 110 is generally similar to prior art socket body 10 but that it has no sleeve, sleeve spring, or sleeve spring retainer, and it has a socket section 116 which generally corresponds to a socket section 16 as in prior art socket body 10 but in which the portion housing locking balls 26 has been cut off. In the Figures, components and features of socket body 110 corresponding to similar or analogous components and features in prior art socket body 10 are referred to by the same reference numbers.

FIGS. 3, 4, and 5 illustrate a socket collar 60 in accordance with the preferred embodiment of the invention. Socket collar 60 is a generally cylindrical element comprising a lobe section 62 and bushing section 64. Lobe section 62 has a cylindrical bore 62A and bushing section 64 has a cylindrical bore 64A, which is substantially coaxially aligned with cylindrical bore 62A. The diameter of bore 64A is smaller than that of bore 62A, and an annular shoulder 66 is formed where bore 62A and bore 64A meet.

Lobe section 62 has a cylindrical wall 63 with outer surface 63A, plus a plurality of locking lobes 70 arrayed circumferentially around cylindrical wall 63 and projecting outward from outer surface 63A. Locking lobes 70 may be aligned along a common circular centerline, as shown in FIGS. 3, 4, and 5; however, locking lobes 70 could also be arranged in a staggered pattern without departing from the essential concept of the present invention. FIGS. 3, 4, and 5 show a total of four locking lobes 70, but this is not essential; alternative embodiments of socket collar 60 may have only two or three or more than four locking lobes 70.

Bushing section 64 has a cylindrical wall 65 with outer surface 65A, which is preferably knurled or otherwise textured to facilitate manual gripping.

FIGS. 6 and 7 illustrate a split bushing 72 for use in mounting socket collar 60 on socket body 110. Split bushing 72 has first end 72A and second end 72B, and comprising two essentially identical and generally semi-cylindrical sections 73. When assembled as shown in FIGS. 6 and 7, split bushing 72 defines a cylindrical passage 74 having a diameter slightly larger than the diameter of mid-section 15 of socket body 116 (a close fit is not required here; there can be a reasonable amount of play between split bushing 72 and surface 15A of mid-section 15 so long as the diameter of passage 74 is less than the maximum cross-sectional dimensions of conduit end 14 and socket end 16 of socket body 110). The length L of split bushing 72 is selected such that split bushing 72 can fit around mid-section 15 without interfering with conduit end 14 and socket end 16 of socket body 116.

Each semi-cylindrical bushing section 73 has a cylindrical outer surface 73A. A semi-annular shoulder 76 projects from outer surface 73A adjacent to first end 72A, and a semi-annular snap ring groove 78 is formed into outer surface 73A adjacent to second end 72B. Therefore, when busing sections 73 are assembled as shown in FIGS. 6 and 7, semi-annular shoulders 76 combine to form a fully annular shoulder 76A, and semi-annular snap ring grooves 78 combine to form a fully annular snap ring groove 78A.

FIG. 11 illustrates how socket collar 60 may be retainingly mounted on socket body 110 in accordance with one embodiment of the present invention, using split bushing 72. First, split bushing 72 is assembled around mid-section 15 of socket collar 60 such that it is partially disposed within annular space 17, with first end 72A of split bushing 72 oriented toward socket section 116. Next, socket collar 60 is slid (from left to right, as viewed in FIG. 11) over split bushing 72 until bushing section 64 of socket collar 60 is clear of snap ring groove 78A, whereupon a snap ring 79 (of well known type) may be snapped into place within snap ring groove 78A so as to prevent socket collar 60 from sliding leftward off split bushing 72. Socket collar 60 is prevented from sliding rightward off split bushing 72 by annular ring 76A, which is adapted to engage annular shoulder 66 of socket collar 60 as shown, Socket collar 60 is thus prevented from sliding off socket body 110, while being free to rotate around it.

It is important to note that FIG. 11 illustrates only one possible way of retainingly mounting socket collar 60 on socket body 110 in accordance with the present invention. Persons of ordinary skill in the filed of the invention will readily appreciate that other modes of mounting socket collar 60 on socket body 110 may be devised in accordance with known principles of design and fabrication without departing from the concept and intended scope of the present invention. Such alternative mounting modes may entail modifications to socket collar 60 and/or socket body 110, and may entail the use of ancillary components not necessarily including a split bushing.

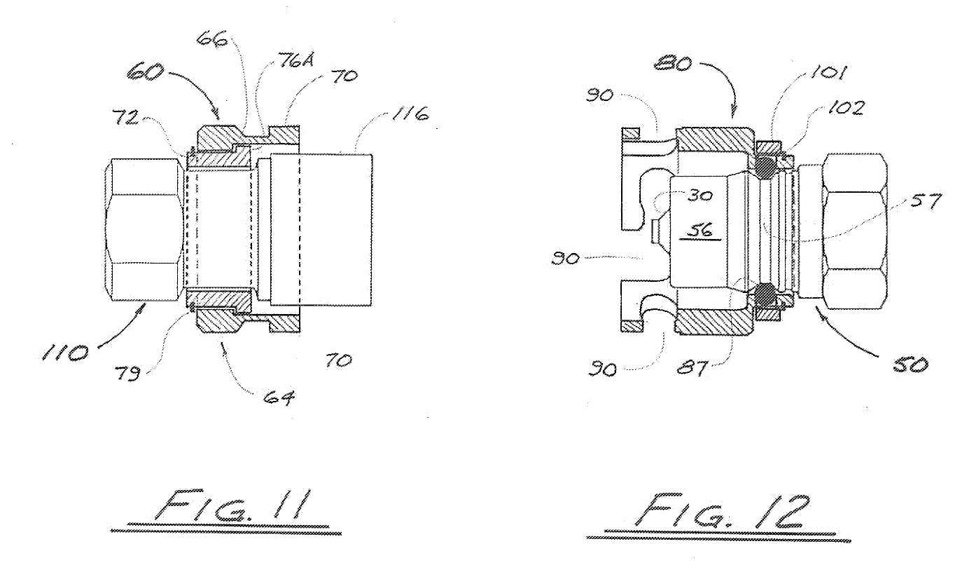

FIGS. 8, 9, and 10 illustrate a plug collar 80 in accordance with the preferred embodiment of the invention. Plug collar 80 is a generally cylindrical element comprising a cylindrical locking ball section 82, a cylindrical central section 86, and a cylindrical slot section 88, all of which are substantially coaxially aligned, with central section 86 being disposed between locking ball section 82 and slot section 88.

Locking ball section 82 has free end 82A and a cylindrical wall 83 which defines a cylindrical bore 83A. A circumferential snap ring groove 84 is formed in the outer surface of cylindrical wall 83 adjacent to free end 82A of locking ball section 82. A plurality of spaced locking ball openings 85 are formed into cylindrical wall 83 in a circumferential pattern between snap ring groove 84 and central section 86. Locking ball openings 85 are configured and adapted to receive and retain spherical locking balls 87 (not shown in FIGS. 8-10) such that they project partially into bore 82A. The diameter of bore 83A is selected such that when plug collar 80 is mounted on plug body 50 (as described below), locking balls 87 can project into locking ball groove 57 of plug body 50.

Central section 86 has outer surface 86A, which is preferably knurled or otherwise textured to facilitate manual gripping.

Slot section 88 has free end 88A and a cylindrical wall 89 which defines a cylindrical bore 89A. A plurality of circumferentially-arrayed and generally L-shaped locking slots 90 are formed into cylindrical wall 89, with one locking slot 90 for each of the locking lobes 70 of socket collar 60. Locking slots 90 may be aligned along a common circular centerline, as shown in FIGS. 8-10, or may be arranged in a staggered pattern, depending on the layout of the locking lobes 70 of socket collar 60. Each locking slot 90 has three parts, namely an entry leg 92, a lateral leg 94, and a detent notch 96. Each entry leg 92 is oriented generally longitudinally relative to plug collar 80 and intercepts free end 88A of slot section 88, such that a corresponding locking lobe 70 may be inserted longitudinally into entry leg 92. Each lateral leg 94 is contiguous with is corresponding entry leg 92, and is oriented generally circumferentially within cylindrical wall 89. Each detent notch 96 is contiguous with its corresponding lateral leg 94, and is disposed toward free end 88A of slot section 88, so as to form a lobe retention element 97 in cylindrical wall 89 between detent notch 96 and entry leg 92.

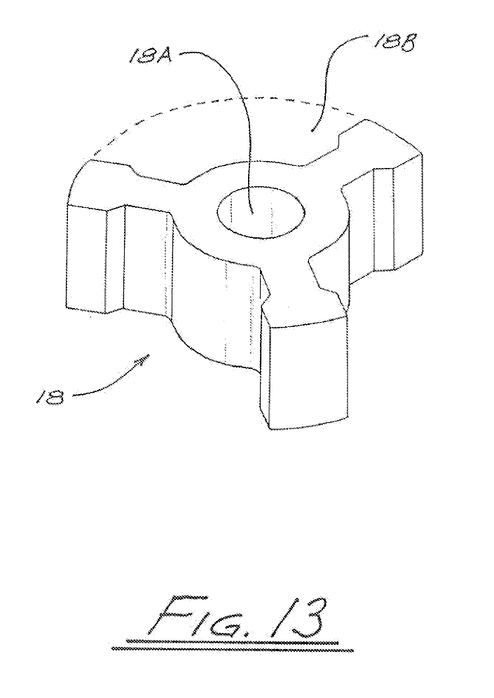

In the preferred embodiment, an enclosure ring 98 (indicated by broken lines in FIGS. 9 and 10) is provided around slot section 88 so as to enclose locking slots 90 and prevent entry of contaminants. It will be readily apparent that in this embodiment of the invention, lobe section 62 of socket collar 60 and slot section 88 of plug collar 80 will be configured and proportioned so that locking lobes 70 can freely enter their corresponding locking slots 90 without interference with enclosure ring 98.

Enclosure ring 98 may be provided in the form of a separate component that is positioned around slot section 88 and welded in place, as suggested in FIGS. 10 and 11. Alternatively, enclosure ring 98 and slot section 88 may fabricated as a unitary element.

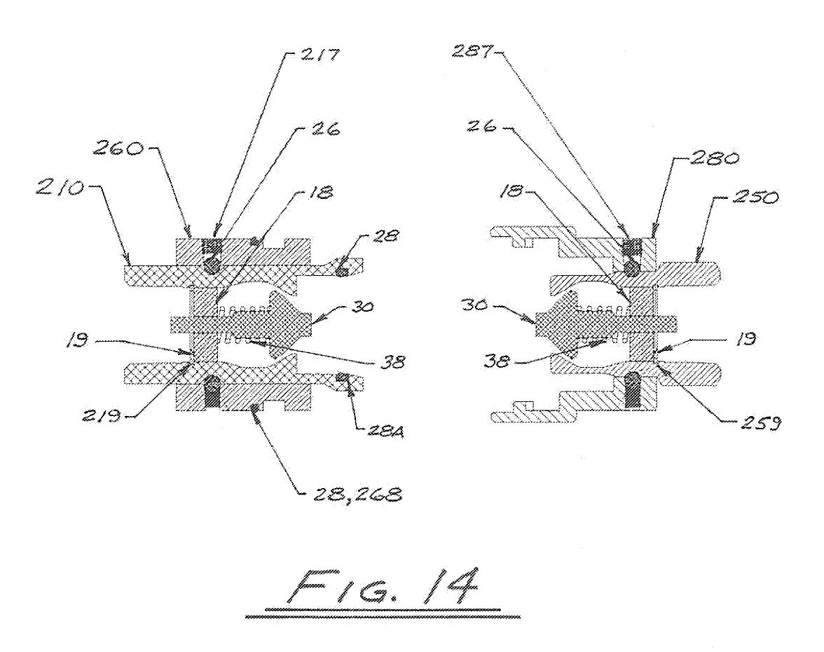

FIG. 12 illustrates how plug collar 80 may be retainingly mounted on plug body 50 in accordance with one embodiment of the present invention. Plug collar 82 is slid (from left to right, as viewed in FIG. 12) over plug body 50 until the locking ball openings 85 of plug collar 80 are aligned with the locking ball groove 57 of plug body 50. Locking balls 87 are then placed in locking ball openings 85, and a ball retainer ring 101 is slipped over locking ball section 82 of plug collar 80. A snap ring 102 is then positioned within snap ring groove 84 in locking ball section 82. Ball retainer ring 101 is thus maintained in position around locking ball section 82 such that is causes locking balls 87 to project partially into locking ball groove 57 of plug body 50. Plug collar 80 is thus prevented from sliding off plug body 50, while being free to rotate around it.

It is important to note that FIG. 12 illustrates only one possible way of retainingly mounting plug collar 80 on socket body 50 in accordance with the present invention. Persons of ordinary skill in the field of the invention will readily appreciate that other modes of mounting plug collar 80 on socket body 50 may be devised in accordance with known principles of design and fabrication without departing from the concept and intended scope of the present invention.

The engagement and disengagement of socket body 110 and plug body 50 in accordance with the present invention may be readily understood from FIGS. 11 and 12. Socket body 110 (with socket collar 60 mounted thereon) and plug body 50 (with plug collar 80 mounted thereon) are brought together in longitudinal alignment, with slot section 88 and central section 86 of plug collar 80 passing over socket section 116 of socket body 110. Locking lobes 70 of socket collar 60 are brought into alignment with and pressed into entry legs 92 of locking slot 90 of plug collar 80. Socket collar 60 and plug collar 80 (and their mountings to socket body 110 and plug body 50 respectively) are configured such that the poppet valves 30 of socket body 110 and plug body 50 will be urged against each other during the insertion of locking lobes 70 into the entry legs 92 of their corresponding locking slots 90, such that both poppet valves 30 will be open when locking lobes 70 have been fully inserted into their corresponding entry legs 92. At this stage, socket collar 60 may be twisted clockwise (in the illustrated embodiment) relative to plug collar 80 so as to move locking lobes 70 into the lateral legs 94 of their corresponding locking slots 90 and adjacent their corresponding detent notches 96. The spring force from valve springs 38 will then urge locking lobes 70 into their corresponding detent notches 96. At this point, socket collar 60 and plug collar 80 are securely interconnected in the longitudinal direction, with relative rotational displacement between them being effectively prevented by lobe retention elements 97.

Separation of socket collar 60 from plug collar 80 is accomplished (with fluid pressure in the connected conduits having been relieved) by pressing socket collar 60 slightly further into plug collar 80 (against the longitudinal force being exerted by valve springs 38) until locking lobes 70 are disposed fully within their respective lateral legs 94 of locking slots 90 and clear of detent notches 96. Socket collar 60 is then twisted counterclockwise relative to plug collar 80 so as to move locking lobes 70 within lateral legs 94 of locking slots 90 until they come into alignment with entry legs 92, whereupon locking lobes 70 may be withdrawn from entry legs 92 (or effectively ejected therefrom as the force in valve springs 38 is released). Socket collar 60 and plug collar 80 are thus separated, with their poppet valves 30 having been closed by their respective valve springs 38.

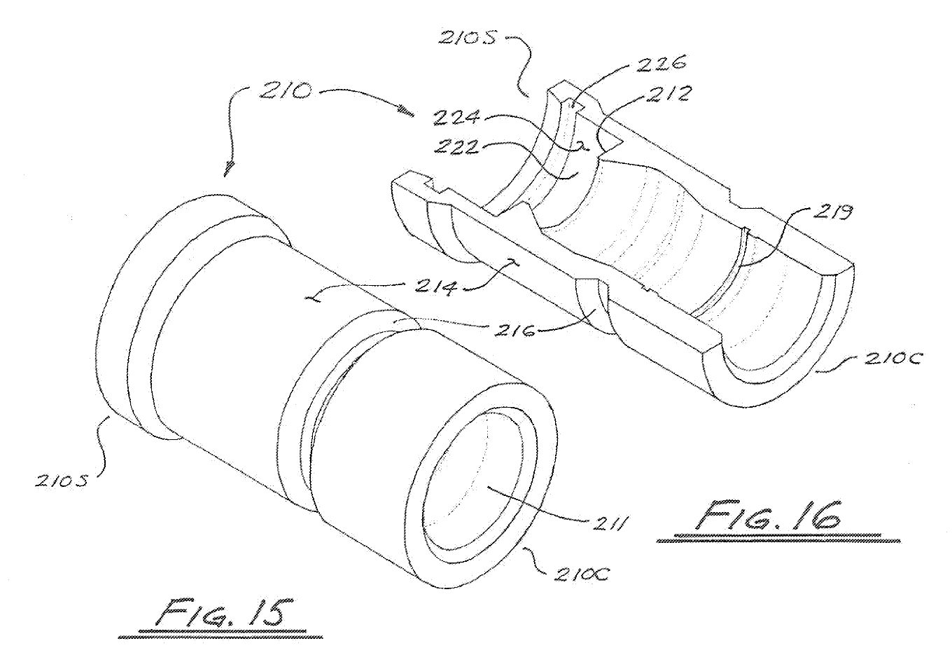

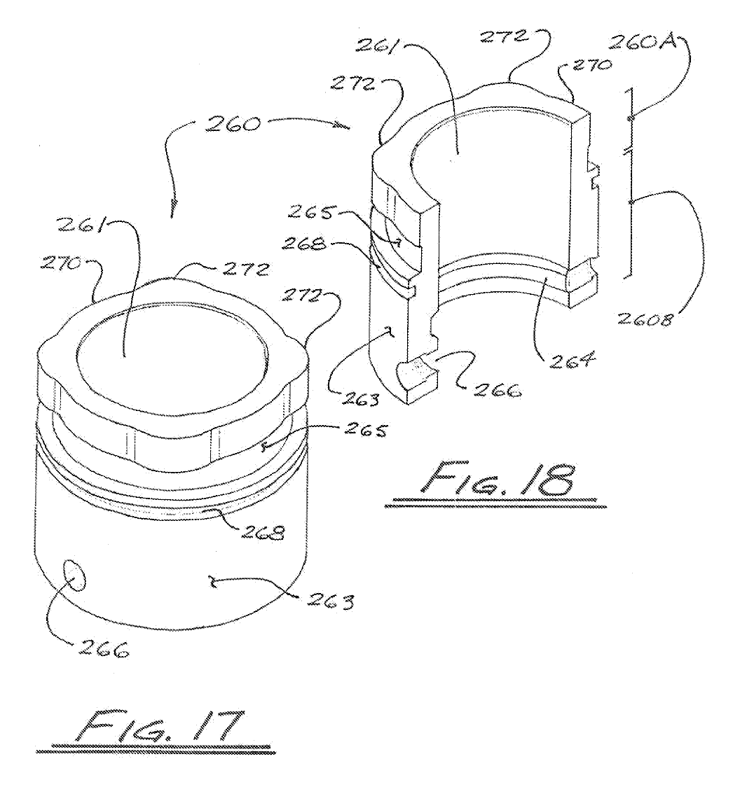

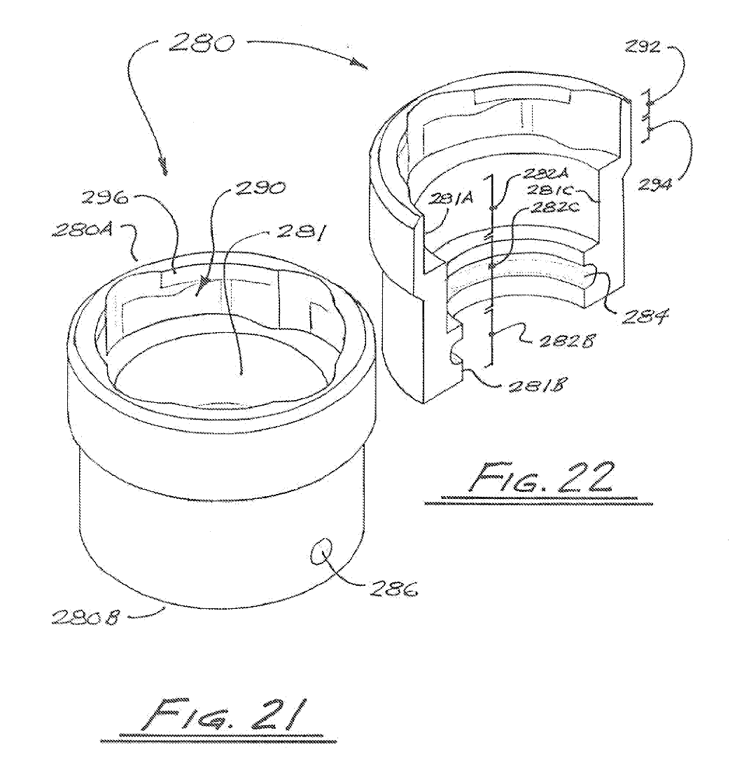

FIGS. 14-22 illustrate an alternative embodiment of the quick coupler of the present invention, having a socket body 210, a socket collar 260, a plug body 250, and a plug collar 280. Referring to FIGS. 14, 15, and 16, socket body 210 has a generally cylindrical passage 211 extending between a conduit end 210C and a socket end 210S, with a spring retainer 18 held in place by suitable means such as an annular snap ring 19 disposed within a snap ring groove 219, all generally as described previously. The bore of passage 211 defines an annular valve abutment 212 analogous to valve abutment 20 previously described. A poppet valve 30, with valve spring 38, is disposed between spring retainer 18 and valve abutment 212. The bore of passage 211 also defines a generally cylindrical socket cavity 222 having a cavity wall 224 and extending between valve abutment 212 and socket end 210S. An annular O-ring groove 226 is formed into the inner surface of cavity wall 224 near socket end 210S, for receiving a socket O-ring 28 (and, optionally, a back-up ring 28A). Socket body 210 has a generally cylindrical outer surface 214, into which is formed an annular locking ball groove 216.

Referring to FIGS. 14, 17, and 18, socket collar 260 is of generally cylindrical configuration, with a cylindrical bore 261 and cylindrical inner surface 262 sized such that socket collar 260 can be rotatably disposed around outer surface 214 of socket body 210 as shown in FIG. 14, preferably but not necessarily with minimal clearance. Socket collar 260 has an inner section 260A and an outer section 260B, and when socket collar 260 is mounted onto socket body 210 as intended in accordance with the invention, inner section 260A and outer section 260B will be disposed toward socket end 210S and conduit end 210C of socket body 210 respectively. An annular locking ball groove 264 in formed into cylindrical inner surface 262 within outer section 260B. Groove 264 is intercepted by one or more locking ball holes 266 (which are preferably threaded) extending radially through the wall of outer section 260B.

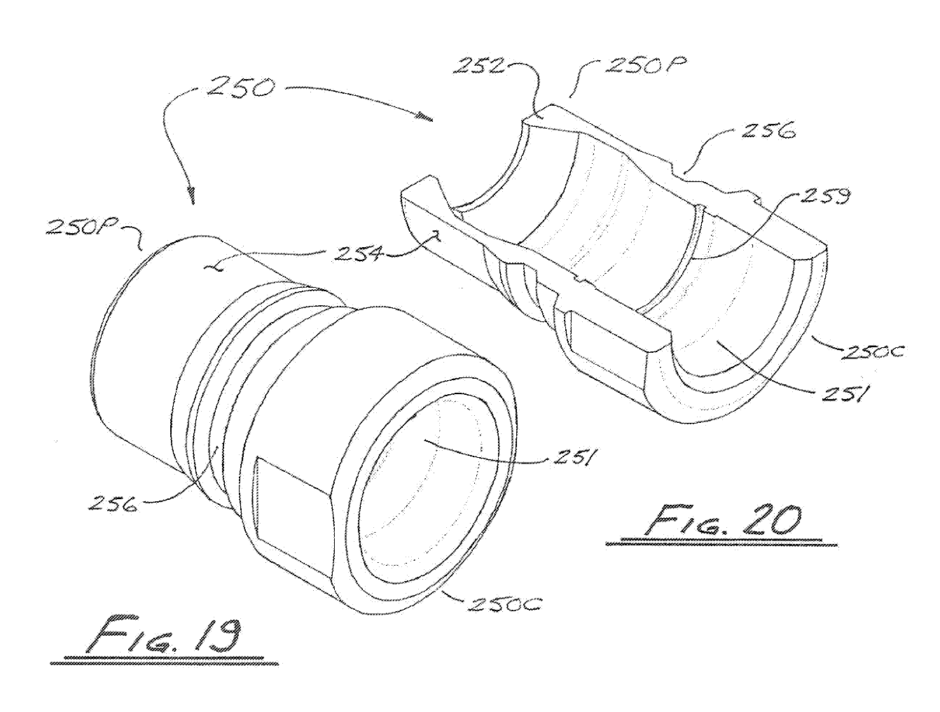

Outer section 260B has a generally cylindrical outer surface 263, and inner section 260A has a generally cylindrical outer surface 265 which is concentric with outer surface 263 but smaller in diameter. An annular O-ring groove 268 is formed into outer surface 263 of outer section 260B at a selected location, preferably adjacent to the transition between outer surfaces 263 and 265 as shown. A plurality of circumferentially-spaced locking lobes 272 project outward from outer surface 265 adjacent to inner end 260A of socket collar 260, with a space 273 being provided between locking lobes 272 and the transition between outer surfaces 263 and 265. Locking lobes 272 may be smoothly faired into outer surface 265, or they may be incorporated into a circumferential flange 270 as shown in FIGS. 17 and 18. In the illustrated embodiment, locking lobes 272 are of generally semi-cylindrical configuration, but other configurations may be used without departing from the essential concept of the invention.

As may be understood from FIG. 14, socket collar 260 may be positioned over socket body 210 with locking ball grooves 216 and 264 aligned so as to form a continuous annular ball race, whereupon a number of locking balls 26 may be inserted into locking ball holes 266 and into the ball race. Suitable retainer means such as set screws 217 may then be positioned in locking ball holes 266 to keep locking balls 26 in the ball race. Locking balls 26 thus act to retain socket collar 260 in a fixed longitudinal position around socket body 210 while being free to rotate therearound.

Referring now to FIGS. 14, 19, and 20, plug body 250 has a generally cylindrical passage 251 extending between a conduit end 250C and a plug end 210P, with a spring retainer 18 held in place by suitable means such as an annular snap ring 19 disposed within a snap ring groove 259, generally as described previously. The bore of passage 251 defines an annular valve abutment 252. A poppet valve 30, with valve spring 38, is disposed between spring retainer 18 and valve abutment 252. Plug body 250 has a generally cylindrical outer surface 254, into which is formed an annular locking ball groove 256.

Referring to FIGS. 14, 21, and 22, plug collar 280 is of generally cylindrical configuration, with an inner end 280A and an outer end 280B, and with a bore 281 of varying diameter. Plug collar 280 has an inner section 282A (having bore 281A) concentrically contiguous with a center section 282C (having bore 281C, which is smaller in diameter than bore 281A) which in turn in concentrically contiguous with an outer section 282B (having bore 281B, which is smaller in diameter than bore 281C). Bore 281B of outer section 282B has formed therein an annular locking ball groove 284. Groove 284 is intercepted by one or more locking ball holes 286 (which are preferably threaded) extending through the wall of outer section 282B. Bore 281B is sized such that plug collar 280 can be rotatably disposed around outer surface 254 of plug body 250 in the region of annular locking ball groove 256, with outer section 280B disposed toward conduit end 250C of plug body 250, all as shown in FIG. 14.

Formed into bore 281A of inner section 282A is a locking slot structure generally indicated by reference character 290. In the illustrated embodiment, locking slot structure 290 has a first segment 292 and a second segment 294. First segment 292 of locking slot structure 290 is disposed adjacent to inner end 280A of plug collar 280, and shaped to permit entry of locking lobes 272 of socket collar 260 (and flange 270, where present), preferably with minimal clearance. Second segment 294, which is disposed axially adjacent to first segment 292, is configured to permit entry of locking lobes 272 from first segment 292, and defines a space or spaces 298 into which locking lobes 272 may be displaced by rotating socket collar 260 relative to plug collar 280 (this may be referred to as the locked position). By virtue of the features of first and second segments 292 and 294 as described above, locking slot structure 290 incorporates an annular radial projection (or projections) 296 serving to prevent axial retraction of locking lobes 272 when in the locked position. Radial projection 296 preferably includes detent sections 298 for preventing relative rotation between socket collar 260 and plug collar 280, in essentially the same fashion as described with respect to other embodiments.

Referring once more to FIG. 14, plug collar 280 is mounted around plug body 250, with their respective locking ball grooves 284 and 256 aligned so as to form an annular ball race. Locking balls 26 may be inserted into locking ball holes 286 into which set screws 287 may then be positioned. Plug collar 280 is thus rotatably retained in a fixed longitudinal position relative to plug body 250, with an annular space 300 being formed between bore 281C of plug collar 280 and outer surface 254 of plug body 250. It will be readily appreciated from reviewing FIG. 14 that when the socket assembly and plug assembly are pressed together in axial alignment, plug end 250P of plug body 250 will enter socket cavity 222 of socket body 210, and socket end 210S of socket body 210 will enter annular space 300, with outer surface 254 of plug body 250 coming into sealing engagement with O-ring 28 of socket body 210. At the same time, locking lobes 272 will pass through first segment 292 and into second segment 294 of locking slot structure 290, while the poppet valves 30 of socket body 210 and plug body 250 are forced against each other, causing them to open. At this point socket collar 260 may be rotated relative to plug collar 280 so as to move locking lobes 272 into the locked position. Upon release of the axial force acting on the assembly, poppet springs 38 will urge locking lobes 272 into corresponding detent sections 298 of radial projection 296.

It will be readily appreciated by those skilled in the art that various modifications of the present invention may be devised without departing from the essential concept of the present invention, and all such modifications and variants are intended to be included within its scope. For example (and without intending to limit the generality of the foregoing statement), in one variant of the invention the locking lobes would be incorporated into the plug collar, and the locking slots would be incorporated into the socket collar. However, the operation of the assembly in this variant would remain essentially the same as for the embodiments specifically described herein.

In this patent document, the word “comprising” is used in its non-limiting sense to mean that items following that word are included, but items not specifically mentioned are not excluded. A reference to an element by the indefinite article “a” does not exclude the possibility that more than one of the elements is present, unless the context clearly requires that there be one and only one such element.

What is claimed is:

1. An apparatus for connecting a pair of fluid conduits, said apparatus comprising:
(a) a socket assembly comprising:
a.1 a socket body having a conduit end, a socket end, a generally cylindrical outer surface, and a generally cylindrical socket bore, said socket bore defining a first annular valve abutment and a socket cavity extending from said first valve abutment to the socket end;
a.2 first spring retainer disposed within said socket bore at a point between the first valve abutment and the conduit end, said first spring retainer having a valve stem opening and one or more fluid openings;
a.3 a first poppet valve disposed within said socket bore between the first spring retainer and the first valve abutment, said first poppet valve having a valve head sealingly disposable against the first valve abutment, a valve stem slidingly disposed within the valve stem opening of the first spring retainer, and a valve spring biasing the valve head against the first valve abutment; and
a.4 a generally cylindrical socket collar having an inner end, an outer end, an outer surface, and an interior bore, said socket collar having first locking means associated with said inner end, and being rotatably mounted around the socket body with said inner end disposed toward the socket end of the socket body;
(b) a plug assembly comprising:
b.1 a plug body having a conduit end, a plug end, a generally cylindrical outer surface, and a generally cylindrical plug bore, said plug bore defining a second annular valve abutment associated with said plug end;
b.2 second spring retainer disposed within said plug bore at a point between the second valve abutment and the conduit end, said second spring retainer having a valve stem opening and one or more fluid openings;
b.3 a second poppet valve disposed within said plug bore between the second spring retainer and the second valve abutment, said second poppet valve having a valve head sealingly disposable against the second valve abutment, a valve stem slidingly disposed within the valve stem opening of the second spring retainer, and a valve spring biasing the valve head against the second valve abutment; and
b.4 a generally cylindrical plug collar having an inner end, an outer end, an outer surface, and an interior bore, said plug collar having second locking means associated with said inner end and configured for engagement with said first locking means, said socket collar being rotatably mounted around the plug body with said inner end disposed toward the plug end of the plug body;
wherein when the socket assembly and plug assembly are pressed together in axial alignment;
(c) the first and second poppet valves will force each other into their respective open positions so as to allow fluid flow through the socket body and the plug body; and
(d) the first locking means will engage the second locking means such that the further step of rotating the socket collar relative to the plug collar will interconnect the first and second locking means so as to prevent relative axial separation thereof.

2. The apparatus of claim 1 wherein the first locking means is a plurality of locking lobes associated with the inner end of the socket collar, and wherein the second locking means is a plurality of locking slots associated with the inner end of the plug collar.

3. The apparatus of claim 2 wherein each locking slot includes a detent section.

4. The apparatus of claim 1 wherein the second locking means is a plurality of locking lobes associated with the inner end of the socket collar, and wherein the first locking means is a plurality of locking slots associated with the inner end of the plug collar.

5. The apparatus of claim 4 wherein each locking slot includes a detent section.

6. The apparatus of claim 1 wherein the valve springs are helical springs disposed substantially coaxially around the valve stems of their respective poppet valves.

7. The apparatus of claim 1, further comprising a split bushing for rotatably mounting the socket collar around the socket body.

8. The apparatus of claim 1 wherein the socket collar is rotatably mounted to the socket body by means of a plurality of locking balls disposed within an annular ball race formed in the outer surface of the socket body.

9. The apparatus of claim 1 wherein the plug collar is rotatably mounted to the plug body by means of a plurality of locking balls disposed within an annular ball race formed in the outer surface of the plug body.

10. The apparatus of claim 1 wherein the outer surfaces of the socket collar and the plug collar have a textured finish to facilitate manual gripping.

11. The apparatus of claim 10 wherein the textured finish is a knurled finish.
